(19) United States
(12) Patent Application Publication
(10) Pub. No.: US 2008/0037933 A1
(43) Pub. Date: Feb. 14, 2008

(54) Speckle reduction using a fiber bundle and light guide

(75) Inventors: Dov Furman, Rehovot (IL); Daniel Mandelik, Rehovot (IL)

Correspondence Address: DORITY & MANNING, P.A., POST OFFICE BOX 1449, GREENVILLE, SC, 29602-1449, US

(73) Assignee: Negevtech, Ltd.

(21) Appl. No.: 11/503,859

(22) Filed: Aug. 14, 2006

(51) Int. Cl. G02B 6/42; G02B 6/26; G02B 6/255; F21V 7/04

(52) U.S. Cl. 385/31; 385/33; 385/38; 385/39; 385/43; 385/95; 385/97; 385/98; 362/551; 362/554; 362/558

(57) ABSTRACT

Illumination of objects in an optical inspection system may utilize an at least partially-coherent light source optically connected to a fiber optic bundle that is linked to a light guide comprising a single optical element. The combination of the bundle and element provides coherence-breaking effects and serves to smooth out angular and spatial non-uniformities. The end face of the light guide may be tapered such that the output end of the light guide is wider than the input end. The illumination system may be configured to illuminate an object such as a semiconductor wafer with critical, Kohler, or other illumination, and may further include a diffuser or other optical elements. The light guide and fiber bundle combination may be used alone or as part of a larger illumination system.

### BACKGROUND

In the semiconductor industry, devices are fabricated by a number of processes to produce precisely-defined structures of an ever-decreasing size. Even the slightest structural defect can ruin a semiconductor device, and so to avoid losses of time and effort, detection of defects is critical before a defective device is mass-produced or further processes are performed on a defective wafer. Fast, on-line detection of wafer defects is possible through the use of optical wafer inspection systems. For example, in some systems, a two-dimensional image of a selected field of view of a wafer is obtained, and that field of view is compared to another view which, under ideal conditions, should be identical. The comparison of like fields of view can thus reveal irregularities which could indicate a defect. In other systems, a two-dimensional image of a selected field of view of a wafer is obtained, and that view is compared to other types of reference views, such as a reference image or images.

To obtain an image of a wafer (or other object), various illumination techniques are used, such as a laser beams. However, a laser beam, especially its coherent nature, may present problems when used as an illuminating source in an application that requires a uniform illuminating light over an area, such as is required in wafer inspection systems. The light may cause interference in the illumination optics and/or patterns on the wafer, each of which may create non-uniformity or artifacts in the image. For instance, scattering of light off surface roughness of optical elements can create speckles, which will increase the noise in the image. Therefore, it is preferable that the effects of the coherent nature of the laser beam be reduced or eliminated through the process known as coherence breaking.

Generally speaking, coherence of a laser beam relates to both spatial coherence and temporal coherence. Spatial coherence generally refers to the phase relation between points in the laser beam spot. The different points may interact with each other in a disruptive or constructive manner when the spot is illuminating a pattern or a rough surface. Spatial coherence generally depends on the mode of the laser beam. For instance, in basic mode, the spatial coherence is defined by the Gaussian profile of the beam. Temporal coherence, on the other hand, is a measure of the time or transit distance over which the phase of the beam can be defined. Temporal coherence generally depends on the laser type and its spectral bandwidth.

Various prior art methods have been described for overcoming coherence effects in laser illumination, such as using a bundle of fibers to transmit the light, wherein the optical path of each fiber is different; a cascade of such bundles; step mirrors; a train of pulses from a single laser pulse; and the use of diffusers. See, for instance, U.S. Pat. Nos. 6,924,891, 6,250,778, 5,233,460, 6,081,381, 6,798,505, and 6,892,013.

Inspection systems may illuminate objects using various illumination arrangements. For example, systems may illuminate objects using critical Illumination and/or Kohler Illumination. FIG. 7A illustrates a generalized exemplary arrangement for critical Illumination. An image of source S, which may be, for instance, the output face of a fiber bundle, is imaged by a condenser (lens L1) onto the object plane OP.

FIG. 7B illustrates a generalized exemplary Kohler Illumination arrangement. A converging lens L2 is placed close to the field stop of source S such that an image of the source appears in the focal plane of condensing lens L3. Light rays from each source point then emerge from lens L3 in a parallel beam. Kohler Illumination may be useful since irregularities in the brightness distribution at the source do not cause irregularities in the field illumination intensity.

Inspection systems that use a bundle of fibers to transmit illuminating light may end up illuminating an object with light having both angular and spatial intensity non-uniformities. Accordingly, use of Kohler and critical illumination may not be sufficient to address such non-uniformities, and may instead simply switch one problem for another by rearranging the underlying illumination problems.

Therefore, further improvements in the distribution of the illumination on the wafer are desirable, as would be improvements in the resolution of the illuminated wafer.

### SUMMARY

A method of illuminating an object in an optical inspection system can include directing at least partially coherent light into a first end of a fiber optic bundle. A bundle may comprise a plurality of optical fibers, and at least some of the fibers may have different optical lengths than the other fibers. The method can further include directing light from a second end of the bundle into a first end of a light guide, where the light guide comprises a single optical element, and illuminating an object with light emitted from a second end of the light guide.

The object may be illuminated by Kohler illumination by using suitable additional optical components. The object may be illuminated by way of critical illumination, semi-critical illumination, or any other type of illumination. As used herein, “semi-critical illumination” includes illumination using critical illumination, but with the end facet defocused (i.e. de-focused critical illumination). The object may be illuminated by light that has passed through a diffusing element, such as a diffuser positioned in the optical path between the light guide and the object, for example, at the facet of the second end of the light guide.

The first end of the light guide may be hot fused to the second end of the fiber optic bundle. Alternatively, the face of the first end of the light guide may be in mechanical contact with the face of the second end of the fiber optic bundle, or may be air spaced from the face of the second end of the fiber optic bundle. The light guide and fiber optic bundle may be optically coupled by way of at least one optical coupling element, such as a lens, diffuser, or other optical element.

The second end of the light guide may be wider than the first end of the light guide so that the light guide has a tapered configuration. The single optical element which comprises the light guide may be a multi-mode fiber, a transparent rod, or a hollow fiber, for example. The fibers of the fiber optic bundle may have different lengths so that the differences in optical lengths between the different fibers are less than, more than, or equal to the characteristic coherence length of the illumination source.

The object may be any type of object that is inspected. Examples of such objects include semiconductor wafers, reticles, or liquid crystal displays. The object may include multiple identical regions.

Illumination apparatus for imaging devices utilizing an at least partially coherent light source can include an at least partially coherent light source, such as a laser, optically linked to at least one bundle of optical fibers. The opposite end of the fiber optic bundle may be optically linked to a first end of a light guide, with the opposite end of the light guide positioned to illuminate an object.

At least some of the optical fibers may have different optical lengths from one another, and the light guide may comprise a single optical element. The light source may be optically linked to the fiber optic bundle by other optical elements, including lenses, filters, air gaps, and/or another light guide.

The light guide and fibers may be hot fused to one another such that they are a single optical unit. Alternatively, the light guide and bundle may be held in mechanical contact with one another, may be air spaced from one another, and/or may be coupled using one or more optical components such lenses, connectors, or other elements. The light guide may be tapered so that the face of the second end of the light guide is wider than the face of the first end. The light guide may comprise a single optical element, such as multi-mode fiber, a transparent rod, or a hollow fiber, for example.

An optical inspection system may comprise at least one imager operative to image an object, at least one illumination source that provides at least partially-coherent light, at least one fiber optic bundle comprising a plurality of optical fibers having different optical lengths from one another, and a light guide comprising a single optical element. The system may be configured such that the fiber optic bundle receives light from the illumination source and provides light to a first end of the light guide. A second end of the light guide may be positioned to illuminate the object. A diffuser may be positioned in the optical path between the second end of the light guide and the object, for example, at the end facet of the light guide.

The system may be configured so that the object is illuminated by critical illumination, i.e. an image of the end plane of the light guide. The system may be configured so that the object is illuminated by Kohler illumination. The system may be configured so that the object is illuminated by semi-critical illumination. Other types of illumination may be used, as well, and the system may be configured to switch between types of illumination. The object, for example, may comprise a semiconductor wafer. The fibers in the bundle may have different optical lengths such that the differences between optical lengths are less than, equal to, or greater than the characteristic coherence length of the illumination source.

The fibers in the bundle may be arranged in groups, wherein within a group all fibers have the same length, but the differences in the lengths between each group are less than, equal to, or greater than the characteristic coherence length of the illumination source. Illumination from the source may be provided directly to the bundle, or may first travel through other components, such an input light guide, optical elements such as lenses and filters, or other suitable conditioning components.

### BRIEF DESCRIPTION OF THE DRAWINGS

A full and enabling disclosure, including the best mode of practicing the appended claims, directed to one of ordinary skill in the art, is set forth more particularly in the remainder of the specification, which makes reference to the appended figures, in which:

FIG. 1 illustrates an exemplary angular distribution of illumination from the end face of a bundle of fibers;

FIG. 2 illustrates an exemplary spatial distribution of light at the output facet of a fiber bundle;

FIG. 2A illustrates an exemplary image of the end face of a fiber bundle;

FIG. 3 illustrates an exemplary arrangement of a fiber optic bundle and a light guide;

FIG. 4 illustrates another exemplary arrangement of a fiber optic bundle and a light guide;

FIG. 5 illustrates a still further exemplary arrangement of a fiber optic bundle and a light guide;

FIGS. 6A-6D illustrate exemplary optical couplings between optical components;

FIGS. 7A & 7B are an exemplary illustrations of the behavior of light in Kohler and critical illumination; and

FIGS. 8 & 9 illustrate examples of optical inspection systems including a fiber optic bundle and light guide arrangement.

Use of like reference numerals in different features is intended to illustrate like or analogous components.

### DETAILED DESCRIPTION

Reference will now be made in detail to various and alternative exemplary embodiments and to the accompanying drawings, with like numerals representing substantially identical structural elements. Each example is provided by way of explanation, and not as a limitation. In fact, it will be apparent to those skilled in the art that modifications and variations can be made without departing from the scope or spirit of the disclosure and claims. For instance, features illustrated or described as part of one embodiment may be used on another embodiment to yield a still further embodiment. Thus, it is intended that the instant disclosure includes modifications and variations as come within the scope of the appended claims and their equivalents.

Inspection systems may use a fiber optic bundle or bundles to reduce speckle and other irregularities. See, for example, the bundle arrangement set forth in U.S. Pat. No. 6,892,013, filed Jan. 15, 2003 and assigned to Negevtech, Ltd., and U.S. patent application Ser. No. 10/345,097, filed Jan. 15, 2003, both of which are hereby incorporated by reference for all purposes herein. Although such prior solutions provide advantages such as coherence breaking, various disadvantages and points for further improvement exist. For instance, the spatial distribution of illumination on the wafer or other object that is illuminated may not be uniform, and the resolution of the image may be degraded.

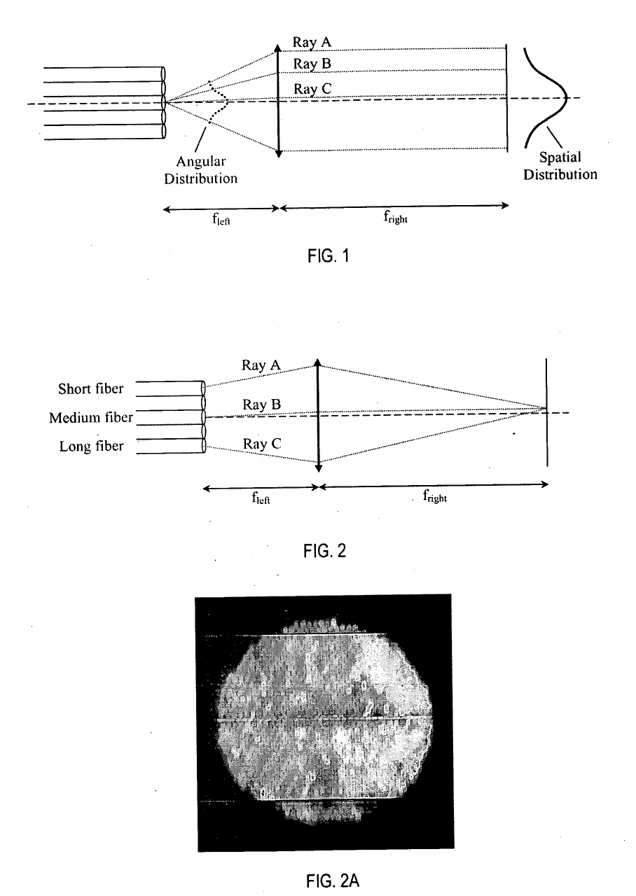

FIG. 1 conceptually illustrates the angular distribution of light at the output facet of a fiber optic bundle and the resulting spatial distribution at the point of illumination. Particularly, FIG. 1 shows the effects of non-uniformities in Kohler illumination. Typically, and as shown in the figure, the illumination at the exit of a fiber has a non-uniform angular distribution, where rays with more acute angles have higher intensity. The object that is illuminated, such as a wafer, will therefore be illuminated in a non-uniform manner. An object positioned perpendicular to the end face of the bundle will receive more light from rays emitted at angles perpendicular and nearly-perpendicular to the bundle end face (i.e. rays similar to ray C) relative to rays emitted at high angles relative to the perpendicular.

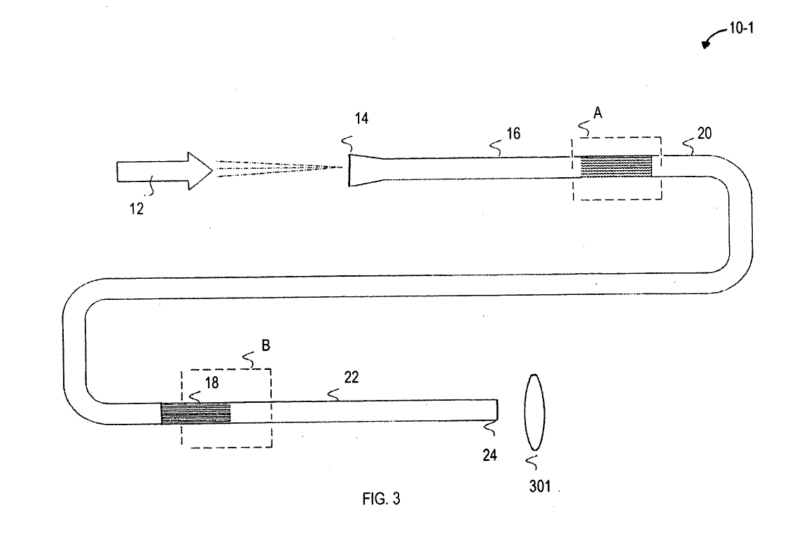

FIG. 2 illustrates another drawback to the use of a fiber bundle alone, specifically that the spatial distribution of intensity at the end of the fiber bundle is not uniform, again illustrating the results when Kohler illumination is used. This is generally due to the fact that some of the fibers in the bundle may have different optical lengths, and accordingly the amount of light transmitted through each fiber is length dependent. Furthermore, imperfections or irregularities in or between fibers in the bundle may deteriorate the spatial distribution further. As shown in FIG. 2, ray A, originating from the short fiber, will have the greatest intensity, with ray B having a lesser intensity, and ray C having a still lesser intensity, since rays B and C both emanate from longer fibers than A.

Therefore, since more energy may be lost in longer fibers, there may be an appreciable variance in the intensity of light at the end of a fiber bundle. FIG. 2A shows an exemplary image of the end face of a fiber optic bundle, with brighter areas having greater intensity than darker areas. Accordingly, any object illuminated with such light will be illuminated in a non-uniform manner. Such non-uniformity leads to undesirable results in an inspection context. For instance, the resolution of an image is degraded when Kohler illumination is used. Alternatively, if critical illumination is used, the object will be illuminated by spatially non-uniform illumination.

The above-mentioned Kohler and/or critical illumination may be used in systems that utilize a fiber bundle. However, there are certain disadvantages that become apparent. For instance, in Kohler illumination, although irregularities in the angular distribution are smoothed out, the angular distribution at the source is mapped to the spatial distribution of illumination at the object plane. Therefore, the non-uniform angular distribution from the fiber bundle can result in non-uniform illumination of the wafer or other object being inspected. Furthermore, in Kohler illumination, spatial non-uniformities are mapped to the angular distribution at the object plane, and the resolution is degraded.

Critical illumination may avoid problems introduced by Kohler illumination, but may substitute others. If critical illumination is used instead of Kohler illumination, the non-uniform spatial distribution of light intensity will be imaged to the object plane. Furthermore, the non-uniform angular distribution of the light will be mapped to the object plane.

When light is used to illuminate an object, an image of that object will be dependent upon light that is reflected or scattered back to an imaging detector or detectors. The resolution of such imaging is dependent on the angular distribution of the light that is reflected and/or scattered from the object. The angular distribution of such reflected/scattered light is dependent on the angular distribution of the light illuminating the object. For example, a wide angular distribution gives finer resolution than a narrower distribution. In most cases, a uniform angular distribution is preferred, either as is, or as a controlled starting point for a more elaborate angular distribution achievable, for example, by adding additional optical components.

As discussed above, use of a bundle along results in both angular and spatial intensity non-uniformities due to the nature of the bundle—i.e., that it is constructed of a number of optical fibers, each of which having non-uniform angular distribution and spatial intensity characteristics. Accordingly, use of Kohler illumination may not be sufficient to address such non-uniformities, and may instead simply switch one problem for another by rearranging the underlying illumination problems. Therefore, further improvements to the uniformity of the underlying angular and spatial distribution of the light are desirable.

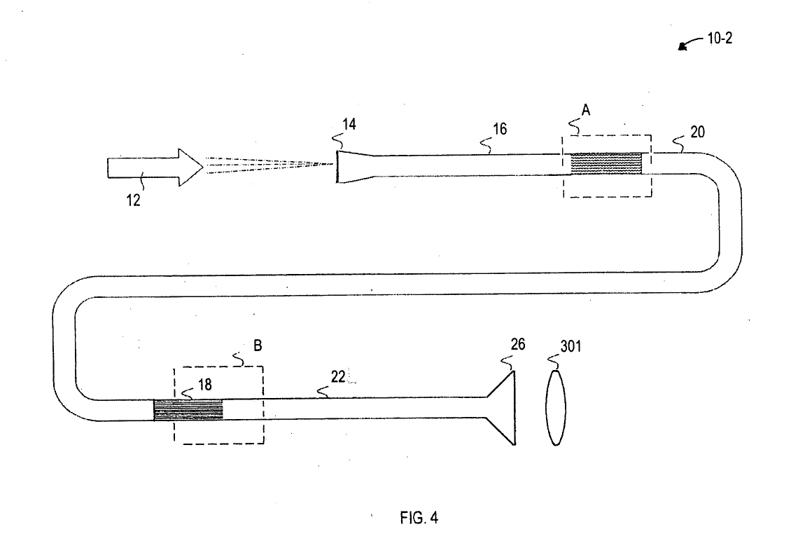

FIG. 3 illustrates an exemplary arrangement 10-1 of optical components which may serve to improve angular distribution and improve spatial distribution as compared to a fiber optic bundle arrangement alone. In system 10-1, light from a source 12 enters the tapered end facet 14 of a first light guide 16. Source 12 is representative of any at least partially-coherent illumination source, such as a laser. Source 12 may comprise, for example, a repetitively pulsed laser source, or CW laser illumination, or other monochromatic, or semi-monochromatic illumination types. For instance, the light may originate from use of the third, fourth, fifth or other harmonics of a ND:YAG or other laser, such as an excimer laser.

The skilled artisan will note that, although a tapered end facet 14 and first light guide 16 are illustrated, the source may be arranged to provide light directly to the end facet of fiber optic bundle 20 in any suitable fashion, such as by a lens, fiber bundle(s), light guides, direct coupling, an air gap, or any other suitable arrangement.

As shown in FIG. 3, a first light guide 16 optically links the light source 12 to a first end of a fiber optic bundle 20. Fiber optic bundle 20 comprises a plurality of optical fibers 18. Fiber bundle 20 may be configured so that optical fibers 18 differ from one another in length in order to provide coherence breaking effects. For instance, individual fibers may be selected so that the difference in length between any two fibers is less than, equal to, or greater than the coherence length of the source illumination. Alternatively, the bundle may comprise groups of fibers that are of identical length within the group, but with differing lengths between the groups, with the differences in group lengths being equal to, greater than, or less than the coherence length of the illumination source.

For example, if the coherence length of source 12 is approximately 8 mm, the difference in length between any two fibers (or fiber groups) will be approximately 8 mm or less, equal to 8 mm, or greater than 8 mm. Alternatively, the fibers (or groups) may vary in length in a non-uniform fashion, or may vary in length such that the difference between individual fibers (or groups) are all greater than, less than, or equal to the coherence length of the source.

Fibers 18 of fiber optic bundle 20 are optically linked to light guide 22, as illustrated at the dotted box B. Light guide 22 (and light guide 16 for that matter) may comprise any single optical element, such as a single multi-mode fiber, a transparent rod, a hollow fiber, or a wave guide. The core diameter of the light guide 22 may be selected so that it is substantially equal to the diameter of the bundle 20. The light guide may be constructed of any suitable material or combinations of materials. For example, the light guide may comprise silica. As a further example, the light guide may be constructed of the same material as that used for the fiber optic bundle or of a different material.

Addition of an output light guide between the fiber optic bundle and the illumination source serves to substantially reduce or eliminate non-uniformities in both the spatial distribution of light and the angular distribution of light illuminating the object under inspection. The fiber optic bundle concept is retained for its advantageous coherence-breaking effects; alternatively, two or more serial bundles may be used, provided the ultimate output of such bundle(s) passes into a light guide.

Dotted boxes A and B illustrate transitions between input light guide 16 and fiber optic bundle 20, and between fiber optic bundle 20 and output light guide 22, respectively. The fiber optic bundle and light guides may be connected to one another in a variety of ways. For instance, in both connection areas A and B, the fibers 18 are fused to light guides 16 and 22, for example by being hot fused into a single optical unit.

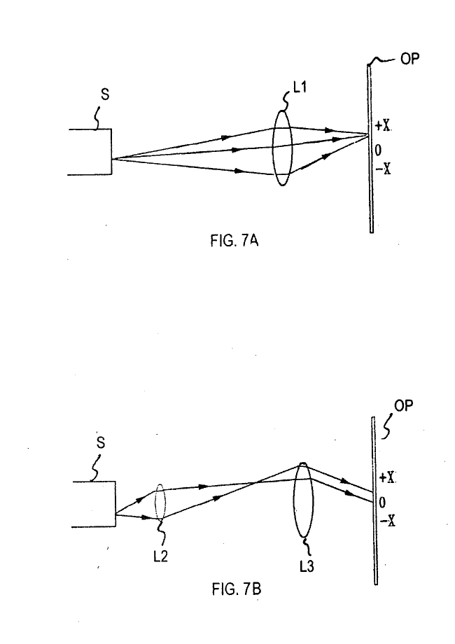

This and other means of connection are illustrated schematically in FIGS. 6A-6D. Although FIGS. 6A-6D show the connection between fiber optic bundle 20 and light guide 22, the connection methodologies are equally applicable to other connections. For instance, similar techniques could be used to connect bundle 22 and input light guide 16 or be used to connect the light guides to other components, such as tapered sections. In certain embodiments, all tapers, light guides, and fibers are hot-fused to one another to form a single optical unit, although in other embodiments a combination of connection methodologies could be used.

FIG. 6A illustrates the fiber optic bundle as being hot fused to light guide 22. In hot-fusing, the components are brought into contact heated to a temperature sufficient to join the components into a single unit without destroying the components or significantly affecting their optical qualities. FIG. 6B shows an alternative connection, in which the end face of bundle 20 is in mechanical contact with the end face of light guide 22, but the components are not fused together. Instead, the faces may be held in contact by any suitable means, such as glue, connectors, clamps, or other suitable structures. In another alternative arrangement, the components may be spaced apart by an air gap, as shown in FIG. 6C, with sufficient structures (not illustrated) to align the end faces as desired. As a further alternative, as shown in FIG. 6D, the bundle and light guide may be optically linked by way of one or more optical components, such as the exemplary lens 28 shown in FIG. 6D. Such components could serve to further condition and modify the light, such as by focusing, diffusing, or filtering, for example. The optical surfaces may be coated with anti reflective coating in order to reduce light loss in the transitions between optical mediums (such as from air to the light guide material, for example).

Returning to FIG. 3, light exits light guide 22 through its end facet 24. As shown in FIG. 3, light enters Kohler imaging lens 301, but such lens is not necessary, for instance, if the object is to be illuminated using critical illumination, as will be discussed in further detail below. Furthermore, although the examples contained herein utilize an input light guide 16 with a tapered input 14, the illumination source 12 may be optically linked to the fiber optic bundle 20 by way of other optical components, either in addition to or in substitution of, the input light guide. In still further alternatives, the illumination source may be arranged to provide light directly to the end facet of fiber optic bundle 20 via directly, or may be optically connected by way of any of the exemplary arrangements shown in FIG. 6.

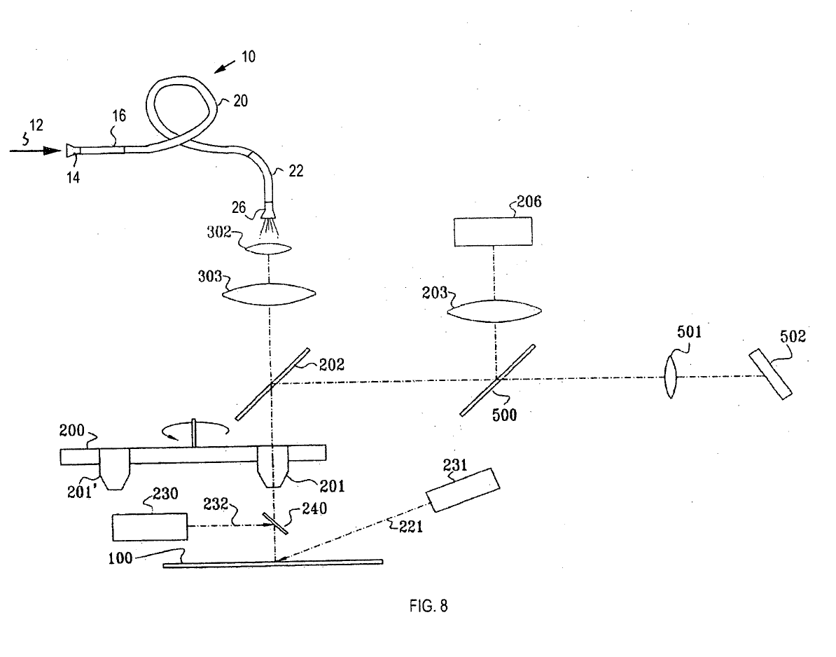

For instance, the illumination system 10-1 could be implemented using an input light guide 16 hot fused to an input taper 14. For instance, the input taper 14 may have an input diameter between 4-6 mm and an output diameter of about 1.35 mm and a length of 100-200 mm. The input taper 14 may be hot-fused to an input light guide 16 having a core diameter matched to the input taper 14 and a length of about 1 m. The input light guide 16 may be hot-fused to fiber optic bundle 20 with a matching numerical aperture (NA). Bundle 20 may comprise 256 fibers, with the shortest fiber being 2800 mm in length and each fiber stepping up in length by 80 mm. Bundle 20 may be hot-fused to an output light guide 22 having a matching NA and core diameter of 1.35 mm, with a length of 14 m. The output end of light guide 22 may be positioned as a source in an optical inspection system directly, or may be positioned so that light first passes through a diffuser and/or other elements such as lens 301 for Kohler illumination, for example. Alternatively, suitable lenses, such as lenses corresponding to L2 and L3 as shown in FIG. 7, may be positioned after the light guide for critical illumination.

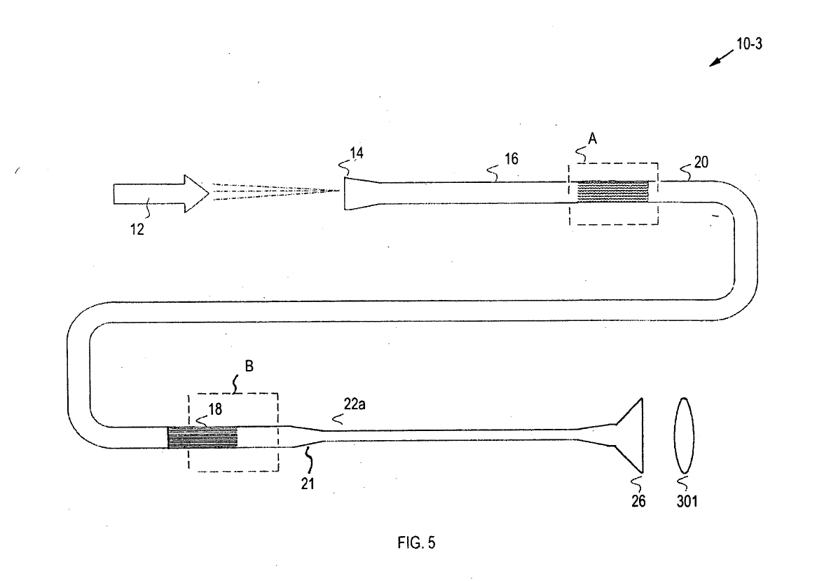

FIG. 4 illustrates an alternative exemplary arrangement 10-2 of optical components similar to those illustrated in FIG. 3. However, as shown in FIG. 4, output light guide 22 includes a tapered end 26. The output taper 26 may be hot fused to the end of light guide 22, or may employ any of the other connection methodologies discussed in conjunction with FIG. 6. A tapered light guide can include any light guide with monotonically variable core diameter.

Tapers may be advantageous as inputs and/or outputs on light guide by allowing injection of high-energy beams into or out of the light guide while avoiding high energy density per-area at the light guide facet where the light guide material encounters the ambient environment (for example, at the interface between silica and air). In the ideal case, the taper is configured so that as the diameter changes, the output beam's numerical aperture changes relative to the input beam so that brightness remains substantially constant inside the taper. Furthermore, the taper may be advantageous, for example, when critical illumination is used, since the relative size of areas of surface non-uniformity will be smaller as compared to the larger facet area.

An illumination system such as 10-2 may be implemented, for example, using an input taper 14 having an initial NA of 0.22 and a final NA of 0.12 matched to the input light guide 16. The input light guide may have, for example, a core diameter of about 0.95 mm and a length of 1.0 meters, and be fused to fiber bundle 20. Fiber bundle 20 may comprise 128 fibers varying in length from about 2800 mm in steps of 160 mm. Bundle 20 may be hot fused to output light guide 22, which may have a length of 25 meters and be fused to output taper 26. Output taper 26 may have an initial diameter and NA matching light guide 22, and taper to an output diameter of 1.35 mm and NA of 0.22 over a length of 100 mm.

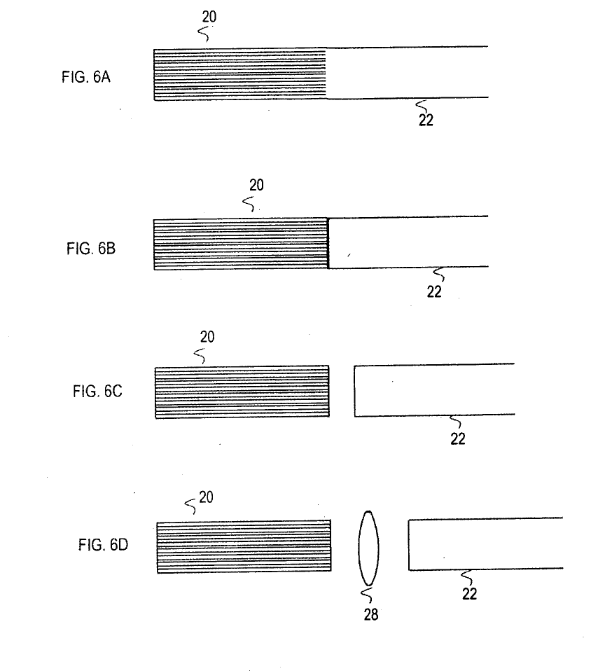

FIG. 5 illustrates another arrangement 10-3 of optical components similar to those in FIGS. 3 and 4. The arrangement of FIG. 5 includes an alternative output light guide 22A which has a smaller core diameter than fiber optic bundle 20. Light guide 22A is connected to the output of fiber optic bundle 20 by way of an interim taper 21, and also includes an output taper 26. The narrower fiber and interim taper may advantageously decrease the losses in the light guide. Those tapers may be hot fused to the light guide or other optical components, or may be connected by way of the methodologies discussed in conjunction with FIG. 6. Additionally, output taper 26 may be omitted in alternative configurations of the illumination system.

Illumination systems such as 10-3 may be implemented, for example, using an input taper 14, input light guide 16, and fiber bundle 20 similar to those discussed above in conjunction with FIG. 4. However, interim taper 21 may be configured to match the input diameter and NA of bundle 20 and transition to an output diameter of 0.5 and NA of 0.22 over a length of 150 mm. Light guide 22a may have a matching NA and diameter, with a length of 7.5 m. Light guide 22a may, for example, be fused to output taper 26 having a matching NA.

In various alternative embodiments, as noted above, fiber bundle 20 may comprise multiple groups of fibers with identical-length fibers within groups, but different lengths between groups. For instance, 256 fibers may be divided into 65 length groups with length variance steps of 625 mm. The number of fibers within each group may be equal, or may vary, for instance with between 3-5 fibers in each group. In a variant of the embodiment shown in FIG. 5, the groups may include the following exemplary distribution:

| Group | No. of fibers | Length (mm) |
|---|---|---|
| 1 to 23 | 3 | 2800 to 16550 |
| 24 to 46 | 4 | 17175 to 30925 |
| 47 to 65 | 5 | 31550 to 42800 |

Of course, the skilled artisan will recognize that particular values discussed herein, such as the numerical apertures, fiber lengths, group lengths, and core diameters, light guide lengths and core diameters, materials, and other figures are presented for purposes of example only. Such values should be selected based on the characteristics of the light source(s) with which the illumination system will operate, keeping in mind the optical characteristics and arrangement of the inspection system in which the illumination system will operate, as well as the characteristics of the objects to be illuminated by the system.

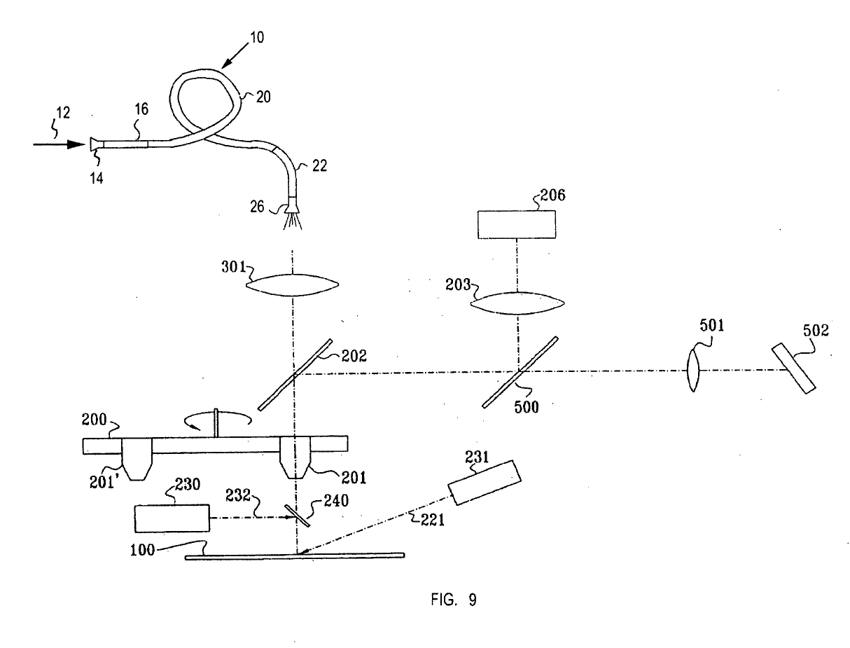

FIGS. 8 and 9 show an exemplary optical inspection system, similar to those illustrated in U.S. Pat. No. 6,892,013, and patent application Ser. No. 10/345,097. However, the exemplary systems shown in FIGS. 8 and 9 employ an optical illumination system, generally denoted as 10, that is configured as discussed in the present disclosure.

At least partially coherent light energy is provided by source 12 into a first end of a fiber optic bundle 20. As discussed herein, the light energy may be provided by way of an input light guide 16 that includes an input taper 14, although other or additional components may be included between the source and the first end of the fiber optic bundle 20. The light is then directed into the first end of a light guide 22, which may be connected to the fiber optic bundle 20 in any suitable manner, for example by hot fusing.

Light output from the light guide 22 may be directed towards an object, such as wafer 100 as illustrated in FIGS. 8 and 9. As shown in FIG. 8, lenses 302 and 303 may be used such that the wafer is illuminated by critical illumination. Alternatively, the output light may be directed through a lens, such as lens 301 illustrated in FIG. 9, so that the object 100 is illuminated by Kohler illumination. Furthermore, although not shown, a diffuser may be included in either or both FIG. 8 and/or FIG. 9 at or near the end facet of the light guide to further improve the angular distribution of the light emitted therefrom.

FIGS. 8 and 9 depict an overall schematic side view including the illumination system of a defect detection apparatus. According to different methods of operation, three alternative modes of illumination are provided: Bright Field (BF), Side-illuminated Dark Field (DF) and Orthogonal or Obscured Reflectance Dark Field (ODF). Each mode of illumination is used to detect different types of defects in different production process steps. For example in order to detect an embedded defect in a transparent layer, such as silicon oxide, BF illumination using the illumination system 10 is preferred. In order to detect a small particle on a surface, DF illumination may yield better results.

In bright field illumination in general, the illumination is incident on the sample through the same objective lens as is used for viewing the sample. As discussed above, FIGS. 8 and 9 show a bright field illuminating laser source 12 delivering its output beam into the fiber optic bundle optically joined to a light guide, which provides for benefits including more uniform illumination on the sample and coherence breaking of the laser illumination. From the output facet of the light guide 22, the laser beam is image onto the objective lens in use 201, which is operative to focus the illumination onto a wafer plane 100 being inspected. As noted above, the embodiment shown in FIG. 9 utilizes a lens 301 to provide Kohler illumination, while the embodiment of FIG. 8 omits such lens in favor of lenses 302 and 303 to achieve critical illumination.

Of course, the particular arrangements of the lenses may be varied by one of skill in the art depending on the optical arrangement of the system to achieve Kohler, semi-critical, critical, and/or other illumination as desired. FIGS. 8 and 9 further illustrate exemplary appropriate alternative objective lenses 201′ that can be swung into place on an objective revolver 200, as is known in the microscope arts. Additional transfer lenses for purposes such as magnification, focusing, and the like may be included as known to one of ordinary skill in the art. For example, an optical inspection system may be arranged to switch between critical, semi-critical, Kohler, and/or other illumination, either manually or automatically.

The illumination returned from the wafer is collected by the same objective lens 201, and is deflected from the illumination path by means of a beam splitter 202, towards a second beam splitter 500, from where it is reflected through the imaging lens 203, which images the light from the wafer onto the detector 206. The second beam splitter 500 is used to separate the light going to the imaging functionality from the light used in other aspects of the inspection tool, such as the auto-focus detector 502 and related components.

When conventional dark field illumination is required for imaging, a dark field side illumination source 231 is used to project the required illumination beam 221 onto the wafer 100. When orthogonal dark field, or obscured reflectance dark field illumination is required for the imaging in hand, an alternative dark field illumination source 230 is used to project the required illumination beam 232 via the obscured reflectance mirror 240 onto the wafer 100 orthogonally from above. Alternatively, rather than three separate sources 12, 230, and 231, a single source or multiple sources in combination may be used. The source(s) may be repositioned, and/or have its output light redirected in order to achieve the different illumination effects.

Although the exemplary systems of FIGS. 8 and 9 depict the fiber and light guide combination in use with a bright-field source, the fiber and light guide combination may be used for any type of illumination, including bright field, dark field, and orthogonal dark-field. For instance, various embodiments of the illumination system 10 may be arranged with each source as appropriate. Alternatively, a single illumination system 10 may be used and the light redirected to achieve the bright field, dark field, and orthogonal dark-field illumination effects. The skilled artisan will appreciate that the fiber/light guide combination may be suitable for use with other illumination types other than those discussed herein.

For example, another type of illumination may include semi-critical illumination, which is similar to critical illumination, with the difference being that the end facet is defocused. Use of semi-critical illumination may advantageously reduce the effects of surface non-uniformities, such as scratches and digs in the glass or other material(s) making up portions of the illumination system. Of course, still further types of illumination are also suitable.

It will be noted by one skilled in the art that the inspection system discussed in the present disclosure is for purposes of example only, and the illumination systems 10 discussed herein and variants thereof are applicable for use in a wide variety of inspection and other systems. The light guide and fiber bundle combination may be used alone or as part of a larger illumination system in other types of inspection tools and in other applications which benefit from uniform illumination, for example.

It is appreciated by persons skilled in the art that what has been particularly shown and described above is not meant to be limiting, but instead serves to show and teach various exemplary implementations of the present subject matter. As set forth in the attached claims, the scope of the present invention includes both combinations and sub-combinations of various features discussed herein, along with such variations and modifications as would occur to a person of skill in the art.

1. A method of illuminating an object in an optical inspection system, the method comprising:
directing at least partially coherent light into a first end of a fiber optic bundle, the bundle comprising a plurality of optical fibers, at least some of the fibers having different optical lengths from the other fibers;
directing light from a second end of the bundle into a first end of a light guide, the light guide comprising a single optical element; and
illuminating an object with light emitted from a second end of the light guide.

2. The method as set forth in claim 1, wherein the object is illuminated by Kohler illumination.

3. The method as set forth in claim 1, wherein the object is illuminated by critical illumination.

4. The method as set forth in claim 1, wherein the object is illuminated by de-focused critical illumination.

5. The method as set forth in claim 1, wherein the first end of the light guide is fused to the second end of the fiber optic bundle.

6. The method as set forth in claim 1, wherein the face of the first end of the light guide is in mechanical contact with the face of the second end of the fiber optic bundle.

7. The method as set forth in claim 1, wherein the face of the first end of the light guide is air spaced from the face of the second end of the fiber optic bundle.

8. The method as set forth in claim 1, wherein the light guide and fiber optic bundle are coupled by way of at least one optical coupling element.

9. The method as set forth in claim 1, wherein the face of the second end of the light guide is wider than the face of the first end.

10. The method as set forth in claim 1, wherein the single optical element is selected from one of the following group: a multimode fiber, a transparent rod, a hollow fiber.

11. The method as set forth in claim 1, wherein at least some of the fibers having different optical lengths comprise fibers having differences in optical lengths therebetween which are greater than or equal to the characteristic coherence length of the illumination source.

12. The method as set forth in claim 1, wherein the object is a semiconductor wafer.

13. The method as set forth in claim 1, further comprising diffusing the light after its exit from the light guide and before the light illuminates the object.

14. Apparatus for reducing speckle in imaging devices utilizing an at least partially coherent light source, the apparatus comprising:
an at least partially-coherent light source;
at least one fiber optic bundle comprising a plurality of optical fibers, at least some of the optical fibers having different optical lengths; and
a light guide comprising a single optical element;
wherein a first end of the fiber optic bundle is optically linked to the light source and a second end of the fiber optic bundle is optically linked to a first end of the light guide.

15. The apparatus as set forth in claim 14, wherein the first end of the light guide is fused to the second end of the fiber optic bundle.

16. The apparatus as set forth in claim 14, wherein the face of the first end of the light guide is in mechanical contact with the face of the second end of the fiber optic bundle.

17. The apparatus as set forth in claim 14, wherein the face of the first end of the light guide is air spaced from the face of the second end of the fiber optic bundle.

18. The apparatus as set forth in claim 14, wherein the light guide is coupled to the fiber optic bundle using at least one optical connection component.

19. The apparatus as set forth in claim 14, wherein the face of the second end of the light guide is wider than the face of the first end.

20. The apparatus as set forth in claim 14, wherein the single optical element is selected from one of the following group: a multimode fiber, a transparent rod, a hollow fiber.

21. The apparatus as set forth in claim 14, further comprising a diffuser positioned at the second end of the light guide.

22. An optical inspection system, the system comprising:
at least one imager operative to image an object;
at least one illumination source, the illumination source providing at least partially-coherent light;
at least one fiber optic bundle comprising a plurality of optical fibers, at least some of the optical fibers having different optical lengths, the bundle being positioned to receive light from the illumination source; and
a light guide comprising a single optical element;
wherein the fiber optic bundle is optically linked to one end of the light guide and a second end of the light guide is positioned to illuminate the object.

23. The system as set forth in claim 22, wherein the system is configured so that the object is illuminated by critical illumination.

24. The system as set forth in claim 22, wherein the system is configured so that the object is illuminated by de-focused critical illumination.

25. The system as set forth in claim 22, further comprising at least one optical element positioned between the end of the light guide and the object such that the object is illuminated by Kohler illumination.

26. The apparatus as set forth in claim 22, wherein at least some of the fibers having different optical lengths comprise fibers having differences in optical lengths therebetween which are greater than or equal to the characteristic coherence length of the illumination source.

27. The apparatus as set forth in claim 22, wherein the object is a semiconductor wafer.

28. The apparatus as set forth in claim 22, further comprising a diffuser positioned in the optical path between the second end of the light guide and the object.
